(19) United States
(12) Patent Application Publication
(10) Pub. No.: US 2024/0052253 A1
(43) Pub. Date: Feb. 15, 2024

(54) SYSTEMS AND METHODS FOR BIOCARBON PRODUCTION

(71) Applicant: CHAR Biocarbon Inc., Toronto (CA)

(72) Inventors: Ning Yan, Toronto (CA); Nicolas Tanguy, Toronto (CA)

(21) Appl. No.: 18/266,453

(22) PCT Filed: Dec. 9, 2021
(86) PCT No.: PCT/CA2021/051768

§ 371 Date: Jun. 9, 2023

Related U.S. Application Data
(60) Provisional application No. 63/124,304, filed on Dec. 11, 2020.

(51) Int. Cl. C10L 9/02; B01D 11/02; C10B 53/02

(52) U.S. Cl. CPC C10L 9/02; B01D 11/0203; B01D 11/0288; C10B 53/02; C10L 2200/0469; C10L 2290/02; C10L 2290/545

(57) ABSTRACT

The present disclosure provides systems and methods for producing biocarbon. In particular, the disclosure provides systems and methods for producing biocarbon from biomass using supercritical CO2 extraction to reduce impurities.

### CROSS REFERENCE TO RELATED APPLICATION

This application claims the benefit of priority to U.S. Provisional Application No. 63/124,304 filed Dec. 11, 2020, the contents of which are incorporated by reference in their entirety.

### FIELD

The present disclosure generally relates to systems and methods for producing biocarbon. In particular, the disclosure relates to systems and methods for producing biocarbon from biomass using supercritical CO₂.

### BACKGROUND

Biocarbon is a coal replacement product made from biomass sources. For example, biocarbon may be used to replace metallurgical coal in the steelmaking industry. Steelmaking requires coal for at least two reasons, first is the energy content of the coal, and second is the solid carbon content of the coal which aids in key chemical processes within a steelmaking furnace. To replace coal for steel making, biocarbon needs to have a high carbon content (which relates to a higher energy density) while containing only low amounts of unwanted minor components, such as alkali metals and phosphorous.

Agriculture and forest biomass residues are attractive feedstocks for production of biocarbon. However, agriculture and forest residues tend to have higher amounts of undesirable minor components inherently as part of their natural growth characteristics. For example, acid washing is commonly used to remove unwanted ash from biocarbon. However, acid washing does not work well, it creates a soup out of the feedstock which needs further processing and it generates liquid chemical wastes.

A new method for producing high carbon biocarbon, which effectively removes unwanted components with a minimum impact on the carbon content is desired.

The use of supercritical CO₂ during food processing is a commercially viable technology (for example decaffeination of coffee). Supercritical CO₂ is capable of targeting specific undesirable compounds. Unlike many traditional solvents, supercritical CO₂ is environmentally friendly as the generation of chemical waste is reduced.

### SUMMARY

The present inventors have shown that biocarbon subjected to supercritical CO₂ extraction has improved properties including reduced alkali metal (K, Na, Ca and Mg) and phosphorus (P) content.

Accordingly, the present disclosure provides a method of producing biocarbon comprising: (a) providing a biomass, (b) converting the biomass to a biocarbon, and (c) contacting the biocarbon with supercritical CO₂ to form a treated biocarbon.

In one embodiment, converting the biomass to a biocarbon comprises pyrolyzing the biomass. Optionally, the biomass is dried prior to pyrolyzing. Pyrolyzing can be performed, for example, at a temperature of 400 to 900° C. for 20 minutes to one hour.

In one embodiment, the method comprises contacting the biocarbon with CO₂ at a temperature of 140 to 220° C. and a pressure of 1400 to 1700 psi, optionally for a time of 60 to 300 minutes.

In one embodiment, the biocarbon is contacted with supercritical CO₂ and at least one chelating agent to form a treated biocarbon. The at least one chelating agent is optionally an ether such as polyethylene glycol dimethyl ether or a crown ether.

In another embodiment, the biocarbon is further contacted with a co-solvent and/or a modifier to form a treated biocarbon. Optionally, the co-solvent is methanol.

In one embodiment, the biomass is or comprises agricultural residue, wood waste, forest residue, anaerobic or acidogenic digestate, animal waste and/or human waste.

In another embodiment, the weight % of alkali metals, alkaline earth metals and/or phosphorus in the treated biocarbon is reduced compared to the first biocarbon, the weight % of Ca, Na, K, Mg, P and/or S in the treated biocarbon is reduced compared to the first biocarbon and/or the ash content of the treated biocarbon is reduced compared to the first biocarbon.

The present disclosure also provides a method of producing biocarbon comprising: (a) providing a biomass, (b) contacting the biomass with supercritical CO₂ to form a treated biomass and (c) converting the treated biomass to a biocarbon.

In one embodiment, converting the treated biomass to the biocarbon comprises pyrolyzing the biomass. Optionally, the biomass is dried prior to pyrolyzing. Pyrolyzing can be performed, for example, at a temperature of 400 to 900° C. for 20 minutes to one hour.

In one embodiment, the method comprises contacting the biomass with CO₂ at a temperature of 140 to 220° C. and a pressure of 1400 to 1700 psi, optionally for a time of 60 to 300 minutes.

In one embodiment, the biomass is contacted with supercritical CO₂ and at least one chelating agent to form a treated biomass. The at least one chelating agent is optionally an ether such as polyethylene glycol dimethyl ether or a crown ether.

In another embodiment, the biomass is further contacted with a co-solvent and/or a modifier to form a treated biomass. Optionally, the co-solvent is methanol.

In one embodiment, the biomass is or comprises agricultural residue, wood waste, forest residue, anaerobic or acidogenic digestate, animal waste and/or human waste.

In one embodiment, the weight % of alkali metals, alkaline earth metals and/or phosphorus in the biocarbon is reduced compared to a biocarbon which has not been converted from biomass contacted with supercritical CO₂, the weight % of Ca, Na, K, Mg, P and/or S in the biocarbon is reduced compared to a biocarbon which has not be contacted with supercritical CO₂ and/or the ash content of the biocarbon is reduced compared to a biocarbon which has not be contacted with supercritical CO₂.

The disclosure also provides a method for separating unwanted components from biocarbon comprising: (a) contacting a biocarbon with supercritical CO₂; and (b) separating the biocarbon from the unwanted components to obtain a treated biocarbon with reduced unwanted components.

In one embodiment, the method comprises contacting the biocarbon with CO₂ at a temperature of 140 to 220° C. and a pressure of 1400 to 1700 psi, optionally for a time of 60 to 300 minutes.

In another embodiment, the biocarbon is contacted with supercritical CO₂ and at least one chelating agent to form a treated biocarbon. The at least one chelating agent is optionally an ether such as polyethylene glycol dimethyl ether or a crown ether.

In another embodiment, the biocarbon is further contacted with a co-solvent and/or a modifier to form a treated biocarbon. Optionally, the co-solvent is methanol.

In one embodiment, the unwanted components comprise alkali metals, alkaline earth metals and/or phosphorus, Ca, Na, K, Mg, P and/or S and/or ash.

The disclosure further provides a biocarbon produced by a method as described herein.

In one embodiment, the biocarbon has an energy content of at least 26, 28, 30, 32, 34, or 36 megajoules per kilogram and an alkali metal and phosphorus content of less than 250 mg/MJ, 220 mg/MJ, 200 mg/MJ, 180 mg/MJ or 160 mg/MJ.

Other features and advantages of the present disclosure will become apparent from the following detailed description. It should be understood, however, that the detailed description and the specific examples while indicating embodiments of the disclosure are given by way of illustration only, since various changes and modifications within the spirit and scope of the disclosure will become apparent to those skilled in the art from this detailed description.

### BRIEF DESCRIPTION OF THE DRAWINGS

FIG. 1 shows a process of supercritical CO₂ extraction of dried biosolid feedstocks.

FIG. 2 shows an experimental setup of a Parr reactor for supercritical CO₂ extraction of feedstocks.

FIG. 3 shows A) weight loss and B) derivative of weight loss of Unprocessed and Processed dried biosolids before supercritical CO₂ extraction and C) weight loss and D) derivative of weight loss of Unprocessed and Processed dried biosolids after supercritical CO₂ extraction.

FIG. 4 shows a comparison of trace elements content before and after extraction with supercritical CO₂ of Unprocessed dried biosolid feedstock via using wet or a combination of dry and wet ashing for digestion.

FIG. 5 shows a comparison of trace elements content before and after extraction with supercritical CO₂ of Unprocessed dried biosolid feedstock and Processed dried biosolid feedstock via using the combination of dry and wet ashing during the digestion step.

FIG. 6 shows testing of dried biosolid char using various chelating agents.

FIG. 7 shows a process for producing biocarbon from a feedstock.

### DETAILED DESCRIPTION

### I. Definitions

Unless otherwise indicated, the definitions and embodiments described in this and other sections are intended to be applicable to all embodiments and aspects of the disclosure herein described for which they are suitable as would be understood by a person skilled in the art.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

As used in this application, the singular forms “a”, “an” and “the” include plural references unless the content clearly dictates otherwise.

### II. Systems and Methods

The present inventors have shown that biocarbon subjected to supercritical CO₂ extraction has improved properties including reduced alkali metal (K, Na, Ca and Mg) and phosphorus (P) content.

Accordingly, the disclosure provides a method for producing biocarbon comprising the steps of converting a biomass to a biocarbon and then subsequently contacting the biocarbon with supercritical CO₂. In another embodiment, the disclosure provides a method for producing biocarbon comprising the steps of contacting a biomass with supercritical CO₂ to form a treated biomass and then converting the biomass to a biocarbon. The disclosure also provides a method of separating unwanted components from biocarbon comprising contacting a biocarbon with supercritical CO₂.

“Biocarbon” (also referred to as “biochar” or “biocoal”) is a carbonized biomass. It is a solid material obtained from the thermochemical conversion of biomass in an oxygen-limited environment. As used herein, the term “treated biocarbon” refers to a biocarbon that has been contacted with (i.e, treated with or exposed to) supercritical CO₂.

As used herein, the term “biomass” refers to any organic material, for example plant matter and animal matter. It includes, but is not limited to, agricultural residue, wood waste, forest residue, anaerobic or acidogenic digestate (for example, by-products of anaerobic digesters), animal waste (for example, manure) and human waste (for example, sewage including sewage sludge and biosolids). The term “feedstock” is also used herein to refer to biomass intended for conversion to biocarbon.

Various methods are known for converting biomass to biocarbon. Generally, biomass is converted to biocarbon under high temperatures in the absence of oxygen or with reduced levels of oxygen, a process known as pyrolysis. The conditions under which pyrolysis is conducted can be adjusted to produce biocarbon with specific properties.

There are a number of types of pyrolysis including conventional or slow pyrolysis, intermediate pyrolysis fast pyrolysis, and ultra-fast or flash pyrolysis. These methods differ in temperature, residence time, heating rate, and products made. For example, slow pyrolysis may be used to minimize the oil produced. Fast pyrolysis and ultra-fast/flash pyrolysis may maximize the gases and oil produced.

For example, in slow pyrolysis, biomass may be heated up to temperatures between 500 and 900° C. for residence times ranging from 30 minutes to one hour. At higher temperatures, more volatile material (for example hydrogen and oxygen) can be driven off to produce a biocarbon with high carbon content.

Torrefaction is another form of slow pyrolysis, where biomass is heated to a temperature of 200-300° C.

In intermediate pyrolysis, residence times and temperatures fall between fast pyrolysis and slow pyrolysis, with a goal of balancing the production of stable biooils and biochars.

In fast pyrolysis, a residence time of one to two seconds is used.

In ultra-fast or flash pyrolysis, biomass may be heated to a temperature of up to 10,000° C.

In one embodiment, biomass is converted to biocarbon by heating the biomass a temperature of 400-900° C., optionally 450-900° C. or 550-850° C. The biomass may be heated to the desired temperature for a residence time of up to one hour, optionally 20 to 60 minutes.

In one embodiment of the methods described herein, pyrolysis is used to produce a high energy biocarbon, for example a biocarbon that has an energy density of at least 25 megajoules per kilogram, optionally a biocarbon that has an energy density of at least 26, 28, 30, 32, 34, or 36 megajoules per kilogram.

In another embodiment, pyrolysis is used to produce a biocarbon with high carbon content, optionally 70% to 95% fixed carbon or 85% to 95% fixed carbon.

Depending on the nature of the biomass it may be necessary to prepare the feedstock prior to pyrolysis.

For example, the biomass may be dried prior to pyrolysis. In one embodiment, the feedstock has moisture content of 25% or less, 20% or less, 15% or less or 10% or less, prior to pyrolysis.

In another embodiment, the biomass may be ground or otherwise manipulated to provide particles of an appropriate size and/or shape. For example, the feedstock may have an average particle size of from 50 micron to 50 mm, or from 1 mm to 10 mm.

Other methods of converting biomass to biocarbon are known in the art and may be used in the methods described herein. For example, hydrothermal carbonization (HTC) can be used to convert biomass to biocarbon through the thermochemical treatment of biomass in pressurized water at relatively low temperatures between 180° C. and 250° C. at or above saturated pressure. Gasification, which utilizes a reduced oxygen environment, may also be used to convert biomass to biocarbon.

As described herein, the inventors have shown that extraction using supercritical CO₂ produces a biocarbon with reduced unwanted components. Therefore, in one embodiment, the biomass is treated (or “extracted”) with supercritical CO₂ prior to conversion to biocarbon. In another embodiment, the biocarbon itself is treated (or “extracted”) with supercritical CO₂.

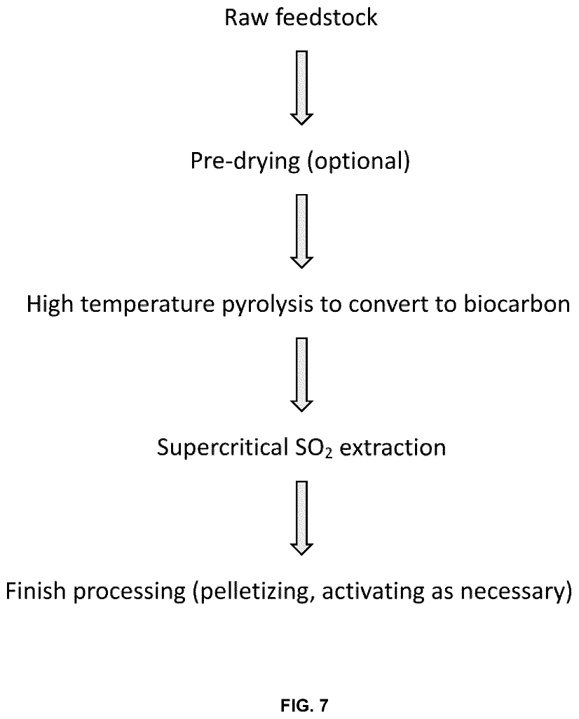

There may be some advantages to treating the biocarbon with supercritical CO₂ rather than the biomass. For example, the yield of biocarbon following pyrolysis may be between 5% and 40%, optionally between 10% and 30%, so there is less material to treat with supercritical CO₂. Also, the fact that much of the volatile material may be driven off during pyrolysis and the material is more porous, could lead to better extraction. FIG. 7 depicts one process for producing biocarbon from a feedstock where the biocarbon is treated with supercritical CO₂ following pyrolysis.

As used herein, the term “extraction” refers to extracting unwanted components or impurities from the biomass or biocarbon. Unwanted components or impurities can include for example, alkali metals, alkaline earth metals, phosphorus, and ash.

As used herein, the term “supercritical CO₂” refers to a fluid state carbon dioxide where it is held at or above its critical temperature (i.e., 31.10° C.) and critical pressure (i.e., 1071 psi).

Therefore, in one embodiment, the biomass or biocarbon is extracted using CO₂, where the CO₂ is at or above its critical temperature and at or above its critical pressure. In one embodiment, the biomass or biocarbon is extracted by contacting the biocarbon with CO₂ at temperature of 140 to 220° C. and a pressure of 1400-1700 psi for 60 mins to 300 mins, optionally at temperature of 140° C., 180° C. or 220° C., a pressure of about 1600 psi for a time of about 1 hour or 5 hours. In another embodiment, the biomass or biocarbon is extracted by contacting the biomass or biocarbon with CO₂ at temperature of 140° C. and pressure of 1400 psi for 60 mins. In another embodiment, the biomass or biocarbon is extracted by contacting the biomass or biocarbon with CO₂ at temperature of 130 to 180° C. and a pressure of 1400-1700 psi for 30 minutes to 90 mins, optionally at temperature of or about 140° C. or 160° C., a pressure of or about 1600 psi for a time of or about 1 hour.

In one embodiment, the extraction is performed at a ratio of biomass or biocarbon to supercritical CO₂ from 1:2 to 1:15, optionally 1:5 to 1:10.

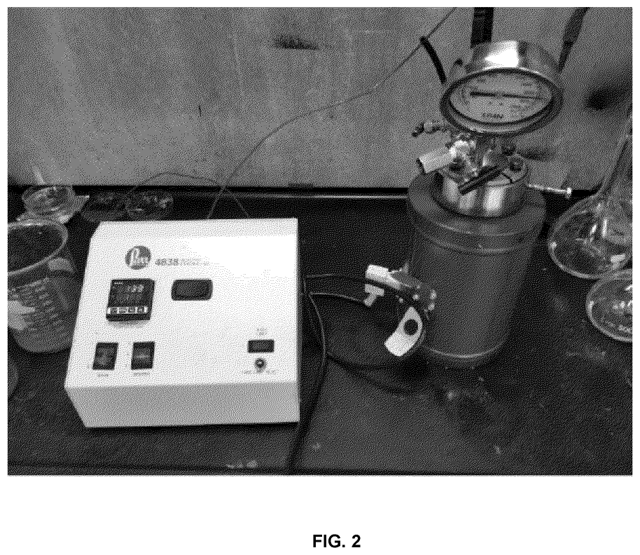

The supercritical CO₂ extraction can occur for example, in a reactor which allows pressure and temperature to be controlled. An example of a suitable reactor is the Parr reactor of FIG. 2. The CO₂ can be provided, for example, in the form of dry ice. CO₂ can be otherwise pumped in the reactor from a CO₂ pressure cylinder to the desired pressure in the reactor.

At least one chelating agent is optionally used in combination with the supercritical CO₂. Thus, in one embodiment, the biocarbon is extracted using a mixture of supercritical CO₂ and at least one chelating agent. As used herein, the term “chelating agent” refers to a chemical compound that binds to metal ions. In one embodiment, the chelating agent is an agent that is soluble in supercritical CO₂. In another embodiment, the chelating agent does not contain nitrogen, sulfur or phosphorus. Examples of chelating agents useful in the methods described herein include ethers, in particular polyoxy-ethylene (for example triethylene glycol dimethyl ether; TegdE and polyethylene glycol dimethyl ether; PegdE), glycol dimethyl ether, polyethylene glycol dimethyl ether and crown ethers (for example 18C6 and 15C5). In one embodiment, chelating agent has a number average molecular weight of 250 g/mol. In another embodiment, the concentration of the chelating agent is kept at a ratio of 1:2, chelating agent:feedstock, by weight.

In addition, at least one modifier is optionally used in combination with the supercritical CO₂. One example of a modifier is an acid that can help the chelating agent to neutralize the charge of an alkali metal. Examples of chelating agents useful in the methods described herein include perfluorocarboxylic acid, lactic acid, citric acid, dodecylbenzene sulfonic acid and ethylenediaminetetraacetic acid. In one embodiment, the concentration of modifier to chelating agent is 1:1 by weight.

Further, at least one co-solvent may be used in combination with the supercritical CO₂. An example of a co-solvent useful in the methods described herein includes methanol (for example, 2.5% to 10% methanol respective to the supercritical CO₂). In one embodiment, the methanol concentration relative to the supercritical CO₂ is 9% to 11%, 10% or about 10%.

In one embodiment, supercritical CO₂ is used with polyethylene glycol dimethyl ether as chelating agent and methanol as co-solvent.

In another embodiment, feedstock is added first, followed by chelating agent and co-solvent. Carbon dioxide (for example dry ice) may then be quickly placed in the reactor and the reactor sealed quickly to prevent loss of CO₂. Co-solvent is optionally added before the carbon dioxide.

Extraction of biomass or biocarbon with supercritical CO₂ can produce biomass or biocarbon with reduced amounts of various unwanted components. These components can include, but are not limited to, alkali metals, alkaline earth metals, phosphorus, and ash. The weight % of any of these components in the extracted biomass or biocarbon may be reduced by at least 1, 5, 10, 50, 75 or 100% compared to biomass or biocarbon that has not been treated with supercritical CO₂.

The present disclosure also provides a biocarbon produced by the methods described herein. In one embodiment, the biocarbon has an energy density of at least 26, 28, 30, 32, 34, or 36 megajoules per kilogram. In another embodiment, the alkali metal and phosphorus content of the biocarbon is less than 250 mg/MJ, 220 mg/MJ, 200 mg/MJ, 180 mg/MJ or 160 mg/MJ. In a further embodiment, the biocarbon has an ash content of less than 15%, less than 10% or less than 5%.

The following non-limiting examples are illustrative of the present disclosure:

### EXAMPLES

### Example 1. Experimental Set-Up for Conducting Supercritical CO₂ Extraction

The application of supercritical CO₂ extraction technology for extraction of agriculture and forest biomass residue as treatment for removal of alkali metals and phosphorous component was investigated. Supercritical CO₂ is a clean and environmental-friendly extraction process that utilizes supercritical CO₂'s unique liquid-like solubility and gas-like permeability properties. The unique penetration and solvation property of supercritical CO₂ is well suited to take out low molecular weight extractives as by-products and remove inorganics, while having no effect on the caloric value that is needed for biocarbon.

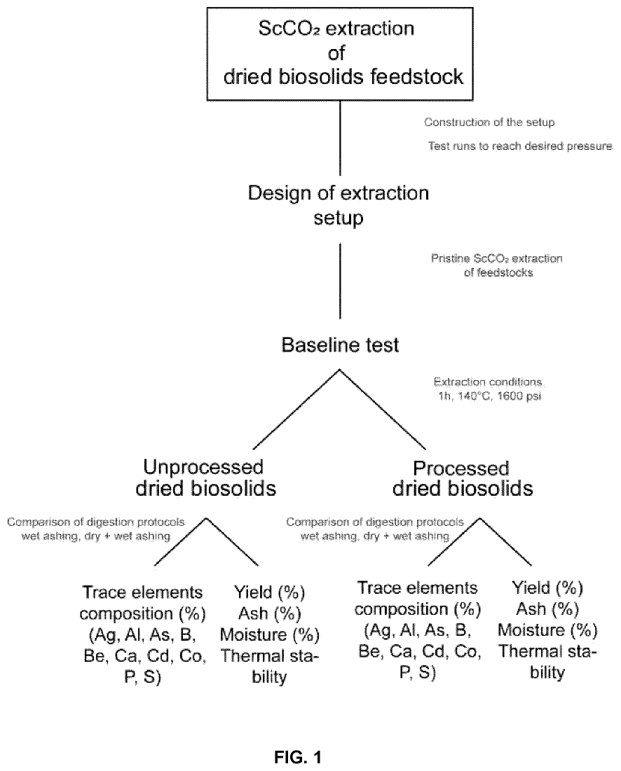

Here, the supercritical CO₂ extraction setup and the protocol used for the extraction of the feedstocks is described. In the initial experiments, the ICP-AES elemental analysis results were compared using two digestion protocols, wet ashing and dry ashing followed by wet ashing. Then, the effect of pristine supercritical CO₂ extraction on the general properties of the dried biosolid feedstocks, which includes volatile/moisture and ash contents, extraction yield and thermal stability was studied. Lastly, the effect of supercritical CO₂ on the trace elements composition of the dried biosolid feedstocks was investigated. A chart of experiments conducted is shown in FIG. 1.

### Methods

Dried biosolid feedstocks were extracted under supercritical CO₂ using a Parr reactor. The Parr reactor is equipped with a rupture disk that can sustain pressure up to 1700 psi. The heating unit attached the reactor allows to conduct experiments at temperatures up to 300° C. The pressure threshold for CO₂ to shift from gas to supercritical fluid behavior is established at 1,071 psi. The selected conditions was 140° C. and a pressure of 1600 psi. Dry-ice was used as source of CO₂. The weight (g) of CO₂ to insert in the reactor was calculated using ideal gas law:

$$n = \frac{P \times V}{R \times T}$$

with P pressure (Pa) in the Parr reactor, V volume of Parr reactor (m³), R gas constant and T temperature of extraction (K). Given reactor volume of 0.6×10−3 m³, desired pressure of 1600-1700 psi, equivalent to 1.275×10⁷, gas constant of 8.31 and temperature of 413 K, the molar content of CO₂ to place in the reactor was determined:

$$n = \frac{1.1 \times {10}^{7} \times 0.6 \times {10}^{- 3}}{8.31 \times 413} \approx 1.92 mol \\ n = \frac{m}{M} ⟺ m = n \times M = 1.92 \times 44 \approx 84 g$$

The reactor, shown in FIG. 2, is loaded by introducing dry-ice together with the feedstock. During the loading, the fast evaporation of the dry-ice leads to losses and the final pressure reached is consistently lower than the desired 1600-1700 psi at 140° C. This was overcome this by adjusting the initial loading of dry-ice to a higher value.

In practice, it was found that inserting 105 g of dry-ice reproducibly yields pressure ranging 1600-1700 psi in the reactor at the selected temperature of 140° C.

Supercritical CO₂ extraction of the feedstocks was conducted by introducing 50 g of Unprocessed (not pyrolyzed) dried pelletized biosolids with a moisture content of around 5% or Processed (pyrolyzed) dried pelletized biosolids together with the dry-ice. The system is quickly sealed and placed in hot water to accelerate the pressurization of the vessel. After 5 minutes in hot water, a pressure of approximately 900 psi is reached and the reactor is transferred in the heating jacket. The system is heated up to 140° C. and kept at temperature for 1 hour. Lastly, the extraction is terminated by a rapid depressurization of the reactor.

### General Properties of Feedstock

Ash content was measured by placing 5 g of feedstock in a furnace at 500° C. in air for 8 hours. Volatile/Moisture content was estimated by placing 1 g of feedstock in the oven at 95° C. overnight.

Samples were tested in duplicates. Extraction yield was determined by measuring the weight of feedstock before and after supercritical CO₂. The yield (%) was calculated as:

$$Yield ( \% ) = ( 1 - \frac{{m}_{b}}{{m}_{a}} ) \times 100$$

with mₐ describing the initial weight of feedstock placed in the reactor and m_{b} describing the weight of feedstock collected after extraction.

The thermal degradation pattern was studied using Thermogravimetric Analysis (TGA-Q500, TA Instruments, USA). 10-30 mg of feedstock was placed in a Platinum pan. The samples were heated to 800° C. under air atmosphere.

### Trace Elements Composition of Feedstocks

### Wet Ashing

Wet ashing was conducted following a modified A7-12 “Standard wet ashing procedures for preparing wood for chemical analysis”. Briefly, 5 mL of HNO3 (70 wt %) and 0.5 g of dry feedstocks were combined in a beaker. The system was boiled until fumes were white, approximatively 10 minutes. The sample was left to cool down and H₂O₂ was added dropwise until sample showed a light colored supernatant. The sample was diluted to 100 mL in volumetric asks. Then, the system was left overnight to allow for the remaining colloids to sediment. Lastly, 10 mL of the supernatants were filed using a membrane with pore size <0:22 μm and tested for trace element analysis via ICP-AES.

### Dry Ashing Followed by Wet Ashing

A preliminary dry ashing step was conducted to remove carbon from the feedstock. Following this treatment, 0.5 g of the ashed feedstock was subjected to wet ashing.

### ICP-AES Characterization

ICP-AES testing was conducted using Optima 7300 DV ICP AES apparatus in the Chemistry department, University of Toronto. A cocktail of 100 μg/mL of Ag, Al, As, B, Be, Ca, Cd, Co and Cr as well as 1000 μg/mL of P and S were used as standards. The ICP-AES was calibrated at 100, 10, 1 and 0.1 ppm of the standard elements. Each system was tested in triplicates. Results were obtained in mg/L equivalent. The final concentration of trace elements after wet ashing was calculated as:

$$Trace elements content ( \% ) = \frac{{E}_{obtained} \times {V}_{diluted solution}}{{m}_{feedstock}} \times ( 1 - Yield ) \times 1000$$

with E_{obtained} describing the value obtained from the ICP-AES, V_{diluted solution} describing the volume of the system after dilution (L), m_{feedstock} the dry weight of feedstock placed in the vial before digestion (kg) and Yield the extraction yield (%) after supercritical CO₂ treatment. 0 was used as Yield for the calculation of trace elements content before CO₂ extraction.

The final concentration of trace elements after dry ashing followed by wet ashing was calculated as:

$$Trace elements content ( \% ) = \frac{{E}_{obtained} \times {V}_{diluted solution}}{{m}_{feedstock}} \times AC \times ( 1 - Yield ) \times 1000$$

with AC describing the ash content (%) and Yield the extraction yield (%) after supercritical CO₂ treatment. 0 was used as Yield for the calculation of trace elements content before CO₂ extraction.

### Results

### General Properties of Feedstocks

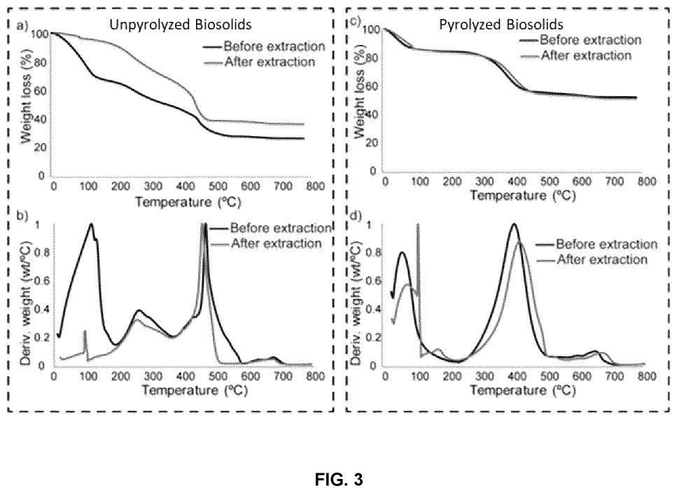

Processed dried biosolids demonstrated higher ash content as compared to Unprocessed dried biosolids. This is expected as the feedstocks underwent pyrolysis under inert atmosphere during processing, which caused the removal of oxygen containing moieties. This results in higher ash content relative to the weight of Processed dried biosolids as compared to Unprocessed dried biosolids. These results were also confirmed by TGA analysis (FIGS. 3A and 3B).

TABLE 1
Ash and Volatile/Moisture content in unprocessed dried
biosolids and processed dried biosolids feed- stocks before and after
supercritical CO₂ extraction

| | | Ash content | Volatile/Moisture |
|---|---|---|---|
| Sample | Treatment | (%) | content |
| Unprocessed biosolids | n/a | 25.8 +/− 0.04 | 33.4 +/− 0.02 |
| | After | 36.8 +/− 0.004 | 4.6 +/− 0.07 |
| | extraction | | |
| Unprocessed biosolids | n/a | 52.1 +/− 1.5 | 20.2 +/− 0.4 |
| | After | 58.5 +/− 0.03 | 12.5 +/− 0.7 |
| | extraction | | |

Unprocessed dried biosolids demonstrated a decrease in the amount of Volatile/Moisture after supercritical CO₂ extraction (33.4% to 4.6%). Some information of the nature of the compounds extracted from the feedstock were obtained from TGA analysis (FIGS. 3A and 3B). A large weight loss was observed at temperature ranging 100 to 200° C. This suggested that the supercritical CO₂ extraction process removed fractions of low molecular weight oils and other non-polar volatiles. The extraction yield following supercritical CO₂ was estimated to 19% for Unprocessed dried biosolids and 15% for Processed dried biosolids.

### Trace Elements Composition of Feedstocks

Trace elements analysis was conducted using ICP-AES. Tested elements were Ag, Al, As, B, Be, Ca, Cd, Co, Cr, P and S. Both the effect of ashing protocol and the effect of supercritical CO₂ on dried biosolidfeedstocks are presented below.

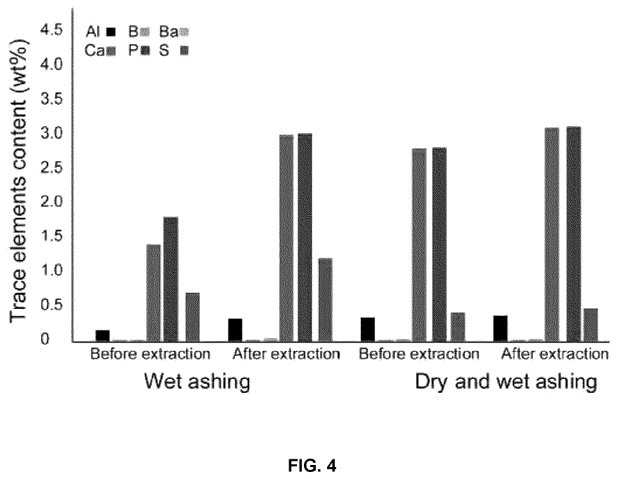

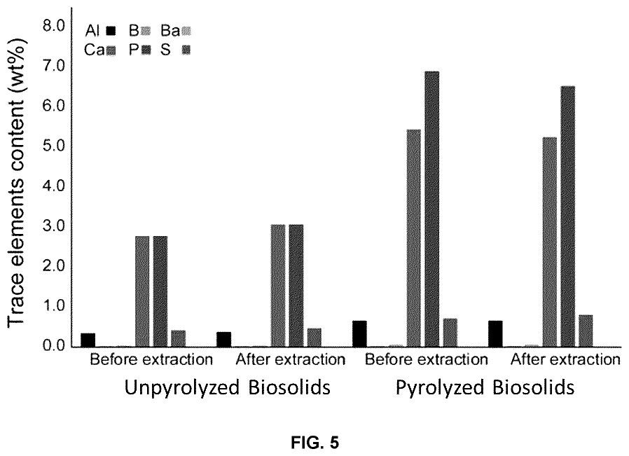

Only the dominant elements are reported in FIGS. 4 and 5. The exact values for all the tested elements can be found in Table 2 and Table 3.

TABLE 2
ICP-AES results after wet ashing of dried biosolid feedstocks.
Feedstocks were characterized before and after supercritical CO₂
extraction.

| | Unprocessed biosolids (wt %) | | Processed biosolids (wt %) | |
|---|---|---|---|---|
| | | After | | After |
| | Before extraction | extraction | Before extraction | extraction |
| Ag | 0.01 | <0.01 | <0.01 | <0.01 |
| Al | 0.1 | 0.3 | 0.6 | 0.6 |
| As | <0.01 | <0.01 | <0.01 | <0.01 |
| B | 0.01 | 0.01 | 0.02 | 0.02 |
| Ba | 0.01 | 0.03 | 0.04 | 0.05 |
| Be | <0.01 | <0.01 | <0.01 | <0.01 |
| Ca | 1.4 | 3.0 | 5.8 | 5.9 |
| Cd | <0.01 | <0.01 | <0.01 | <0.01 |
| Co | <0.01 | <0.01 | <0.01 | <0.01 |
| Cr | :0.01 | <0.01 | <0.01 | <0.01 |
| P | 1.8 | 3.0 | 7.5 | 7.6 |
| S | 0.7 | 1.2 | 7.4 | 7.5 |

TABLE 3
ICP-AES results after consecutive dry ashing and wet ashing of
dried biosolid feedstocks. Feedstocks were characterized before and
after supercritical CO2 extraction.

| | Unprocessed biosolids (wt %) | | Processed biosolids (wt %) | |
|---|---|---|---|---|
| | | After | | After |
| | Before extraction | extraction | Before extraction | extraction |
| Ag | <0.01 | <0.01 | <0.01 | <0.01 |
| Al | 0.3 | 0.3 | 0.6 | 0.6 |
| As | <0.01 | <0.01 | <0.01 | <0.01 |
| B | <0.01 | <0.01 | 0.01 | 0.01 |
| Ba | 0.03 | 0.03 | 0.05 | 0.05 |
| Be | <0.01 | <0.01 | <0.01 | <0.01 |
| Ca | 2.8 | 3.1 | 5.5 | 5.3 |
| Cd | <0.01 | <0.01 | <0.01 | <0.01 |
| Co | <0.01 | <0.01 | <0.01 | <0.01 |
| Cr | <0.01 | <0.01 | <0.01 | <0.01 |
| P | 2.8 | 3.1 | 6.9 | 6.6 |
| S | 0.4 | 0.5 | 0.7 | 0.8 |

### Effect of Ashing Protocol

The ICP-AES results of Unprocessed biosolids following different digestion protocols are depicted in FIG. 4. Trace elements composition (TEC) results were consistent between wet ashing and dry and wet ashing for Unprocessed biosolids after extraction. However, Unprocessed biosolids TEC results before extraction using wet ashing were low as compared to that of following dry and wet ashing. It is suggested that the source of this variation may be explained by some losses of material while adding hydrogen peroxide. For this specific sample, a fast and aggressive foaming took place, and some of the product was lost out of the test vial. It is suggested that dry ashing followed by wet ashing is generally beneficial due to the use of higher initial content of material in the analysis, which may reduce the error incurred by potential variability in feedstocks composition. As well, the removal of most of the carbon from the feedstock via dry ashing favours slower and milder foaming while adding hydrogen peroxide.

### Effect of Supercritical CO₂ Extraction

TEC results showcased no difference after supercritical CO₂ extraction for Unprocessed and Processed biosolids, as shown in FIG. 5. This result is expected as CO₂ under supercritical conditions does not interact with alkali metals, phosphorus or sulfur. Nevertheless, the treatment allowed for the extraction of low molecular weight volatiles, likely oils, from Unprocessed biosolids.

In this study, the experimental setup for conducting supercritical CO₂ is shown along with the baseline results of pristine (pure CO₂ without any modifiers, cosolvents or chelating agents) supercritical CO₂ of Unprocessed and Processed biosolid feedstocks. These initial findings indicated that the treatment, on its own, does not favour the extraction of metals, phosphorus and sulfur. Success in the removal of these compounds may require using a co-solvent extraction system or chelating agents.

### Example 2. Selection of Modifier, Co-Solvent and Chelating Agents

In order to successfully extract alkali metals and alkaline earth metals from the dried biosolid feedstocks provided using supercritical CO₂, a number of parameters may be considered including (1) solubilities of chelating agents and metal chelates, (2) temperature and pressure, (3) the time of extraction, (4) the use of solvent modifier and (5) the use of co-solvents. Considering the extremely low polarity of CO₂, due to the symmetric C═O bonds that cancel the dipoles in the molecule, the ability to solubilize the chelating agents in CO₂ becomes important in achieving high metals recovery (Ding et al., 2017). In addition to the restriction due to solubility, the desired application of the feedstock as coke prevents the use of nitrogen or phosphorus containing chelating agents, and thus the families of dithiocarbamates and organophosphorus chelating agents.

Another approach to improve the solubility of the chelating agent and metal chelates is to introduce a co-solvent. The co-solvent must exhibit a certain level of miscibility with CO₂ as well as a low boiling point to enhance metals recovery.

The following chelating agents were tested: 1) cocktail of 18C6 and 15C5 crown ethers and 2) triethylene glycol dimethyl ether and decaethylene glycol dimethyl ether polyoxy-ethylenes. Perfluorocarboxylic acid solvent modifiers were also added to improve the solubility of the metal chelates. Lastly, 5% methanol as co-solvent in the CO₂ was tested in conjunction with the modifier and chelating agent. For all systems, the extraction temperature, pressure and time was kept at 160° C., 1600 psi and 1 hour.

### Example 3. Supercritical CO₂ Extraction for Production of High Quality Coke

A Parr Reactor (FIG. 2) was modified for supercritical CO₂ operations. Parameters for controlling pressure within an appropriate range were tested (maximum pressure of 1700 psi, maximum temperature of 350° C.).

### Initial Testing

As described above, FIG. 4 shows testing conditions of 140° C., 1500 psi with a loading ratio of 1:5 (feedstock:CO₂). Little effect of sCO₂ extraction on selected metals/alkali metals/alkaline earth metals (N, AL, Ca, S, B and P) was seen. Comparable results were obtained using two distinct digestion protocols.

### Addition of Chelating Agents

Two groups of chelating agents were tested: polyoxy-ethylenes (triethylene glycol dimethyl ether; TegdE and polyethylene glycol dimethyl ether; PegdE) and crown ethers:

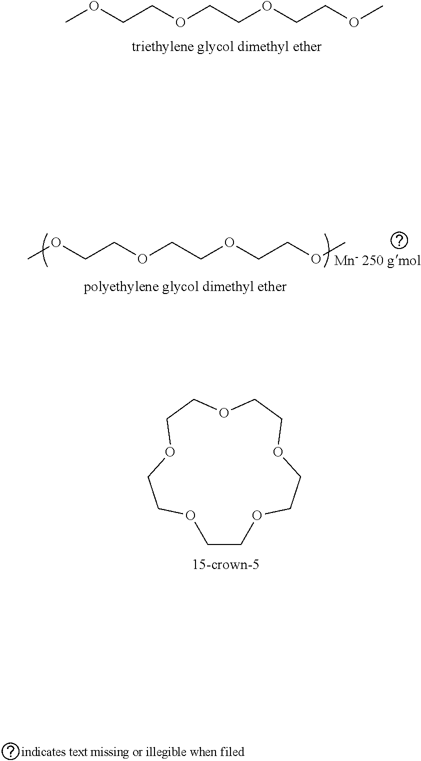

Without being bound by theory, it is believed that an interaction between alkali metals and ethers from the chelating agent may assist in the supercritical CO₂ treatment:

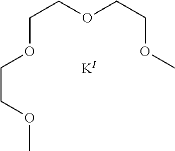

### Addition of Chelating Agent and Modifier

The addition of both a chelating agent and modifier for neutralizing the alkali charge was also tested. Examples of potential modifiers include perfluorcarboxylic acid and dodecyl benzene sulfonic acid.

Without being bound by theory, it is suggested that acid functionality could help the chelating agent to neutralize the charge (Mochizuki et al, Anal. Commun., 1999a, 36-51). Further, the fluorocarbonated chain could increase the solubility of the chelating alkali metals.

### Testing Results

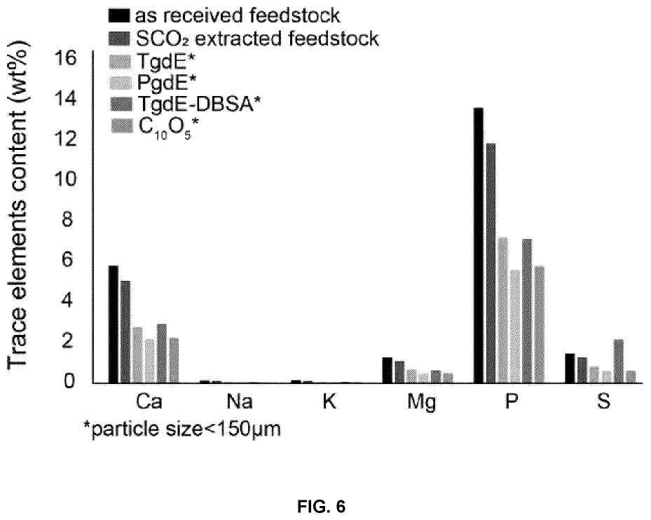

FIG. 6 shows testing of biochar formed under various conditions. Dried pelletized biomass with a moisture content of around 5% was pyrolzed using a temperature of 700-800° C. and 23 minute residence time. Following pyrolyzation, the resulting biocarbon was either not treated (“as received feedstock”), extracted with SCO₂ (“SCO2 extracted feedstock”) or extracted with SCO₂ as described in Example 1 in the presence of various chelators (TgdE, PgdE, 15-Crown-O5) or a combination of chelator and modifier (TgdE-DBSA).

The concentration of the chelating agents concentration was kept at 1:2, chelating agents:feedstock, by weight. Feedstock was added first, followed by chelating agent. Dry-ice (carbon dioxide) was the quickly placed in the reactor and the reactor sealed immediately.

As seen in FIG. 6 and Table 4, below, using a chelator during supercritical CO₂ extraction resulted in a decrease in alkali metal composition. In particle, a decrease in P content by 58 wt % and Ca content by 62 wt % using PgdE was observed. Addition of the modifier (dodecyl benzene sulfonic acid (DBSA)) did not improve the extraction efficiency.

TABLE 4
Testing of dried biosolid char (detailed WT %)
Processed biosolids (wt %)

| | Before | After | | | TGDE- | |
|---|---|---|---|---|---|---|
| | extraction | extraction | TgdE | PgdE | DBSA | 15-crown-O-5 |
| Ca | 5.83 | 5.10 | 2.80 | 2.22 | 2.95 | 2.26 |
| Na | 0.14 | 0.13 | 0.07 | 0.05 | 0.07 | 0.05 |
| K | 0.17 | 0.14 | 0.08 | 0.06 | 0.07 | 0.06 |
| Mg | 1.29 | 1.10 | 0.69 | 0.49 | 0.64 | 0.51 |
| P | 13.67 | 11.90 | 7.20 | 5.64 | 7.16 | 5.80 |
| S | 1.49 | 1.28 | 0.84 | 0.62 | 2.18 | 0.62 |

### SUMMARY

There was a significant decrease in the metal content after supercritical CO₂ extraction using chelating agents. Polyethylene glycol dimethyl ether demonstrated good chelating potential.

Optimizing other factors, including the temperature and biomass to CO₂ weight ratio, may increase the solubility of the chelating agent and improve extraction yield.

1. A method of producing biocarbon comprising:
(a) providing a biomass,
(b) converting the biomass to a biocarbon, and
(c) contacting the biocarbon with supercritical CO₂ to form a treated biocarbon.

2. The method of claim 1, wherein converting the biomass to the biocarbon comprises pyrolyzing the biomass, optionally wherein the biomass is dried prior to pyrolyzing.

3. (canceled)

4. The method of claim 1, comprising contacting the biocarbon with CO₂ at a temperature of 140 to 220° C. and a pressure of 1400 to 1700 psi, optionally for a time of 60 to 300 minutes.

5. The method of claim 1, wherein the biocarbon is contacted with supercritical CO₂ and at least one chelating agent to form the treated biocarbon.

6. The method of claim 5, wherein the at least one chelating agent is an ether, optionally a Polyethylene glycol dimethyl ether or a crown ether.

7. (canceled)

8. The method of claim 5, wherein the biocarbon is further contacted with a co-solvent and/or a modifier to form the treated biocarbon, optionally wherein the co-solvent is methanol.

9. (canceled)

10. The method of claim 2, wherein the pyrolyzing is performed at a temperature of 400 to 900° C. for 20 minutes to one hour.

11. The method of claim 1, wherein the biomass is or comprises agricultural residue, wood waste, forest residue, anaerobic or acidogenic digestate, animal waste and/or human waste.

12. The method of claim 1, wherein the weight % of alkali metals, alkaline earth metals and/or phosphorus in the treated biocarbon is reduced compared to the biocarbon, the weight % of Ca, Na, K, Mg, P and/or S in the treated biocarbon is reduced compared to the biocarbon, and/or the ash content of the treated biocarbon is reduced compared to the biocarbon.

13. A method of producing biocarbon comprising:
(a) providing a biomass,
(b) contacting the biomass with supercritical CO₂ to form a treated biomass and
(c) converting the treated biomass to a biocarbon.

14. The method of claim 13, wherein converting the treated biomass to the biocarbon comprises pyrolyzing the biomass, optionally wherein the biomass is dried prior to pyrolyzing.

15. (canceled)

16. (canceled)

17. The method of claim 12, wherein the biomass is contacted with supercritical CO₂ and at least one chelating agent to form the treated biomass.

18. The method of claim 17, wherein the at least one chelating agent is an ether, optionally wherein the at least one chelating agent is a Polyethylene glycol dimethyl ether or a crown ether.

19. (canceled)

20. The method of claim 17, wherein the biomass is further contacted with a co-solvent and/or a modifier to form the treated biomass, optionally wherein the co-solvent is methanol.

21. (canceled)

22. (canceled)

23. (canceled)

24. The method of claim 14, wherein the weight % of alkali metals, alkaline earth metals and/or phosphorus in the biocarbon is reduced compared to a biocarbon which has not been converted from biomass contacted with supercritical CO₂, the weight % of Ca, Na, K, Mg, P and/or S in the biocarbon is reduced compared to a biocarbon which has not be contacted with supercritical CO₂ and/or the ash content of the biocarbon is reduced compared to a biocarbon which has not be contacted with supercritical CO₂.

25. A method for separating unwanted components from biocarbon comprising:
(a) contacting a biocarbon with supercritical CO₂; and
(b) separating the biocarbon from the unwanted components to obtain a treated biocarbon with reduced unwanted components.

26. (canceled)

27. The method of claim 25, wherein the biocarbon is contacted with supercritical CO₂ and at least one chelating agent to form a treated biocarbon, optionally wherein the at least one chelating agent is an ether, and optionally wherein the at least one chelating agent is a Polyethylene glycol dimethyl ether or a crown ether.

28. (canceled)

29. (canceled)

30. The method of claim 27, wherein the biocarbon is further contacted with a co-solvent and/or a modifier to form a treated biocarbon, optionally wherein the co-solvent is methanol.

31. (canceled)

32. The method of claim 25, wherein the unwanted components comprise alkali metals, alkaline earth metals, phosphorus, Ca, Na, K, Mg, P, S and/or ash.

33. (canceled)

34. (canceled)

35. A biocarbon produced by the method of claim 1.

36. (canceled)
